(19) United States
(12) Patent Application Publication
(10) Pub. No.: US 2013/0167948 A1
(43) Pub. Date: Jul. 4, 2013

(54) Anti-Theft Assembly

(71) Applicant: Steven Scott Marion, Bethleham, GA (US)

(72) Inventor: Steven Scott Marion, Bethleham, GA (US)

(21) Appl. No.: 13/734,907

(22) Filed: Jan. 4, 2013

Related U.S. Application Data
(60) Provisional application No. 61/583,170, filed on Jan. 4, 2012.

(51) Int. Cl. F16K 35/00

(52) U.S. Cl. CPC F16K 35/00
USPC 137/383

(57) ABSTRACT

An anti-theft assembly for preventing illegal access to a water shut-off point of a commercial flush valve assembly is disclosed. The anti-theft assembly is comprised of a boxed configuration formed and dimensioned for installation in both a left and right oriented flush valve assembly with lock access holes positioned to hold a lock between the plumbing fixtures and the wall.

The present application claims the benefit of U.S. application No. 61/583,170, filed Jan. 4, 2012 and titled ANTI-THEFT DEVICE, which is herein incorporated by reference in its entirety.

### FIELD OF THE INVENTION

The technology described herein relates generally to theft deterrent devices. In particular, the technology described herein relates to devices for preventing theft of commercial plumbing fixtures.

### BACKGROUND OF THE INVENTION

Skyrocketing prices for metals, especially copper, have made what was once a minor nuisance into a major problem costing over $1 billion/year according to the U.S. Department of Energy. Pipes, wires, cables, gutters, flashing are being torn from walls and buildings. Roof-top air units are being stripped of their copper coils. Thieves target copper in vacant buildings or difficult to secure areas, often without power or communication lines including:
Construction Sites—theft of copper plumbing, wiring, generators and materials.
Vacant Buildings—theft of copper plumbing, wiring, air conditioners.
Communications Towers—theft of copper bus bars, wiring and cables.
Electrical Sub-stations—theft of copper grounding bars and cables.
Foreclosed Properties—theft of copper plumbing, wires, sprinkler systems, and cooling systems.

In addition, the collateral damage done ripping pipes and wires out of walls far exceeds the actual cost of the copper stolen.

Recently thieves have targeted commercial plumbing toilet fixtures in the bathrooms of fast food establishments. Typically the thief enters the bathroom, locks the door, shuts off the water supply by accessing the water shutoff valve, removes the chrome covered brass fixtures, places them in a bag, and exits the bathroom, all just a few minutes, with minimum noise. This is accomplished using tools that are easily purchased.

The next patron to enter the bathroom typically does not notice the missing pipes, attempts to flush the toilet, notices that nothing happens, informs management, management calls for a plumber, and the plumber installs a new fixture.

The theft results in both a hefty bill for replacement of the fixtures, plus the aggravation of a smelly bathroom and patrons not being able to use the bathroom until repairs are made, which could be for several days.

Because the theft can be carried out quickly with little chance of detection, thieves have been known to return to the same victimized establishment for repeat thefts. Additionally, multiple establishments in the same area are generally victimized on the same day as the thief accumulates brass fixtures to convert into cash.

The need exists to deter theft of bathroom plumbing that is accessible by the public.

### BRIEF SUMMARY OF THE INVENTION

The technology described herein pertains to devices configured for deterring theft of toilet water supply plumbing fixtures that are publically accessible.

In an exemplary embodiment the technology described herein comprises an anti-theft assembly for commercial flush valve assemblies.

The anti-theft assembly is configured for securing a commercial flush valve by lockably encasing the water shut-off and detachment nut. The anti-theft assembly is formed and dimensioned to secure the water shut-off and detachment nut in either a left or right configuration. The anti-theft assembly is formed from a material of sufficient hardness and thickness to resist attempts to disable, compromise or remove the device, e.g., metal, plastic, and composites. The lock access points of the anti-theft assembly are arranged to position the locking mechanism such that a thief is deterred from removing the lock.

In an exemplary embodiment the anti-theft assembly base is configured to be a substantially rectangular-style box, having one open side, having a partial opening (encasement cut) on the side adjacent to the open end, with the remaining sides closed. Two of the facing closed sides have paired opposing apertures, e.g., drill holes, dimensioned to accommodate the shank portion of a long shank lock, or equivalent. The lock can be a keyed lock, combination lock, word lock, voice lock, or the like.

The anti-theft assembly base can be formed in shapes other than rectangular.

In another embodiment the anti-theft base has an array of paired opposing drill holes formed to accommodate multiple shank locks, or equivalent locking structures or assemblies.

To install the anti-theft assembly, the partially open side is placed on the water shutoff valve such that the anti-theft assembly is substantially horizontal to the floor. The anti-theft assembly base is adjusted to fit tight against the water shutoff valve with the encasement cut side facing the water shutoff valve and preventing access to the inlet water shutoff valve. This orientation results in the open side engaging the plumbing fixture adjacent to the water shutoff valve such that the apertures are positioned past the rear side of the adjacent fixture in order for a locking assembly to be installed. The shank portion of a shank lock in the open position is inserted into the opposing aperatures. The shank portion of the shank lock is then closed into the shank lock body thus securing access to the water shutoff valve.

In another embodiment of the technology described herein, a separate lock support is utilized. The lock support has a bolt-head proximal end and an aperture distal end. The lock support is inserted into the opposing drill holes with the aperture distal end being first inserted into the bottom opposing hole until the bolt-head proximal end is tight against the bottom side. A lock in the open position is then inserted into the aperture distal end and locked.

In yet another embodiment the lock support is inserted into the opposing drill holes with the aperture distal end being first inserted into the top opposing hole until the bolt-head proximal end is tight against the top side. A lock is then inserted into the aperture distal end and locked.

An aspect of the technology described herein is that it provides a solution to the problem of theft of flush valves assemblies.

Another aspect of the technology described herein is that is provides a durable device that protects access to the water shut-off point.

Another aspect of the technology described herein is that it is easy to install.

Another aspect of the technology described herein is that it provides a device that is economical to manufacture.

Another aspect of the technology described herein is that it provides a device that is easy to learn how to install.

Another aspect of the technology described herein is that it can be in different colors and have different indicia disposed thereon.

There has thus been outlined, rather broadly, the features of the present invention in order that the detailed description that follows may be better understood, and in order that the present contribution to the art may be better appreciated. There are additional features of the invention that will be described and which will form the subject matter of the claims. Additional aspects and advantages of the present invention will be apparent from the following detailed description of an exemplary embodiment which is illustrated in the accompanying drawings. The invention is capable of other embodiments and of being practiced and carried out in various ways. Also, it is to be understood that the phraseology and terminology employed are for the purpose of description and should not be regarded as limiting.

### BRIEF DESCRIPTION OF THE DRAWINGS

The technology described herein will be better understood by reading the detailed description of the invention with reference to the accompanying drawing figures, in which like reference numerals denote similar structure and refer to like elements throughout, and in which:

FIG. 1 illustrates an anti-theft assembly, illustrating, in particular, an anti-theft assembly with a correspondingly sized shank lock, according to an embodiment of the technology described herein;

FIG. 2 illustrates an anti-theft assembly, illustrating, in particular, an anti-theft assembly with a correspondingly sized lock support and lock, the lock support positioned for top insertion into the paired apertures, according to an embodiment of the technology described herein;

FIG. 3 illustrates an anti-theft assembly, illustrating, in particular, an anti-theft assembly with a correspondingly sized lock support and lock, the lock support positioned for bottom insertion into the paired apertures, according to an embodiment of the technology described herein;

FIG. 4 illustrates an anti-theft assembly, illustrating, in particular, an anti-theft assembly assembly installed on a commercial toilet plumbing assembly, according to an embodiment of the technology described herein;

FIG. 5 illustrates an anti-theft assembly base; and

FIG. 6 illustrates an anti-theft assembly base.

### DETAILED DESCRIPTION OF THE INVENTION

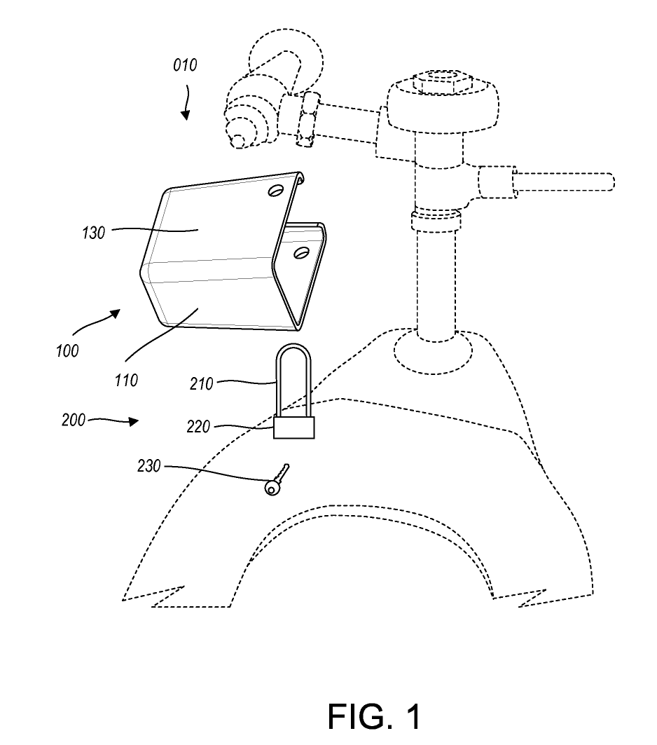

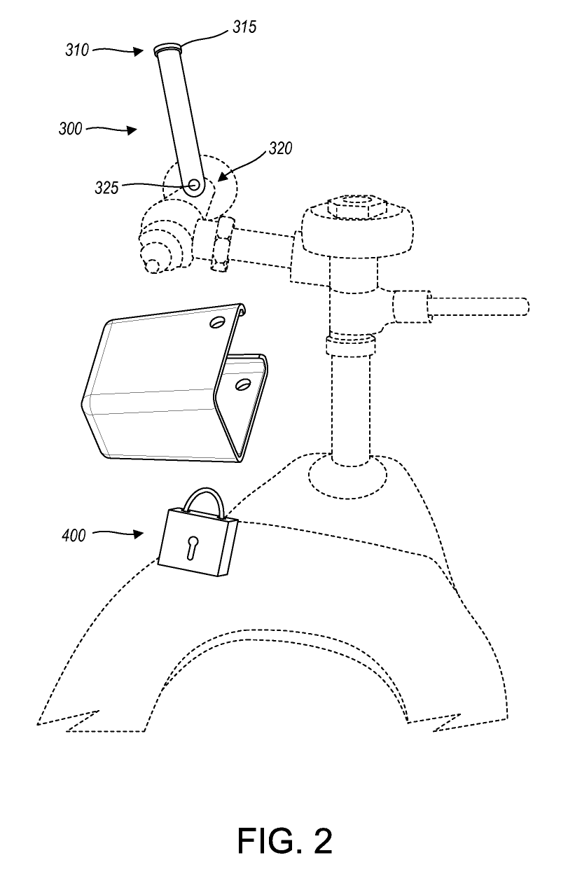

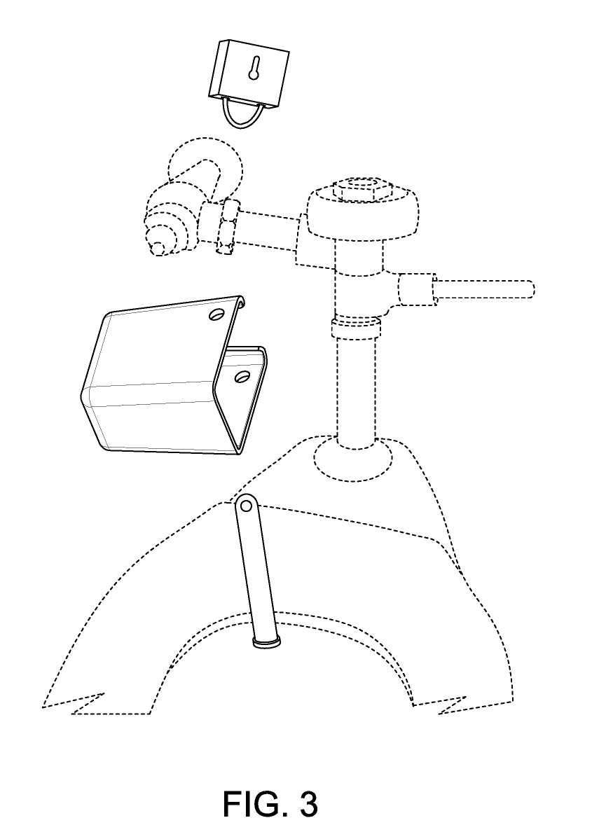

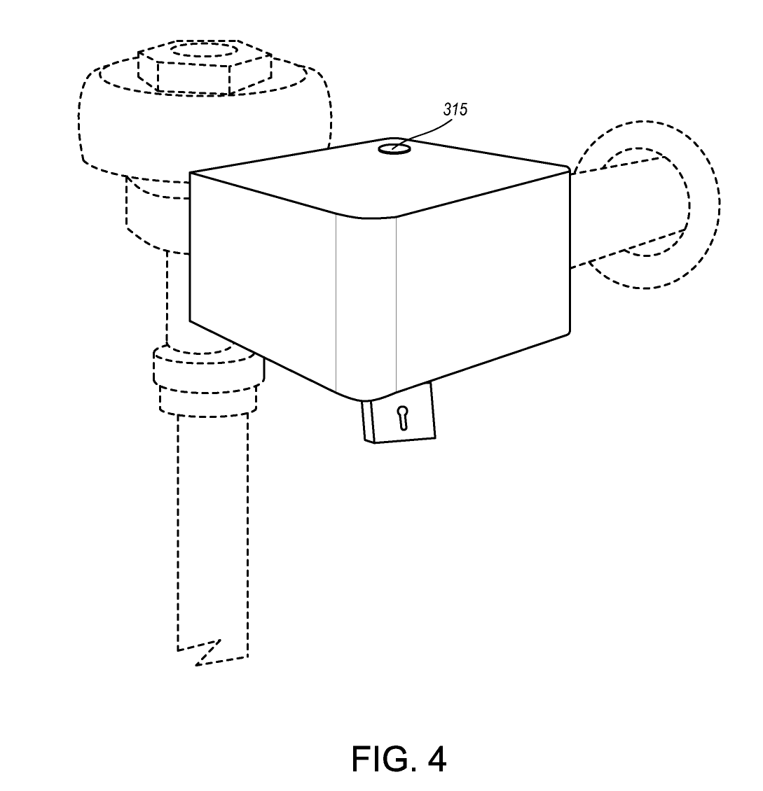

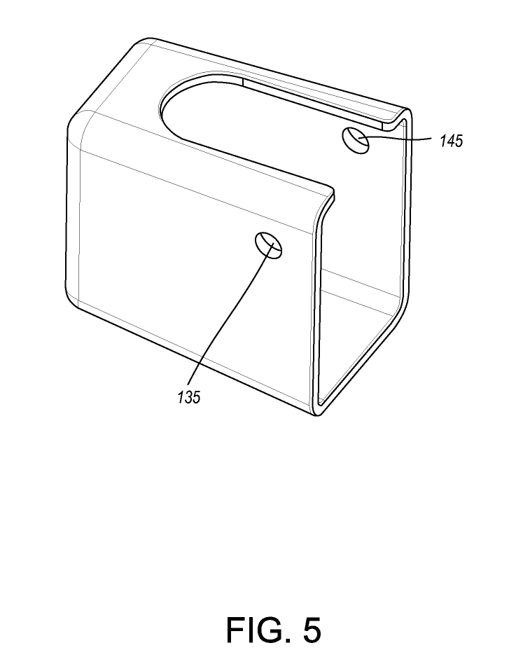

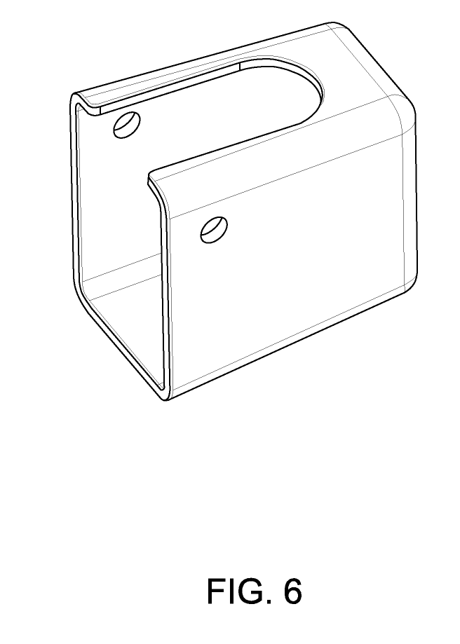

In describing the preferred and other embodiments of the technology described herein, as illustrated in FIGS. 1-6, specific terminology is employed for the sake of clarity. The invention, however, is not intended to be limited to the specific terminology so selected, and it is to be understood that each specific element includes all technical equivalents that operate in a similar manner to accomplish similar functions.

Referring now to FIGS. 1-6, illustrated therein is a device for deterring access to the water shut-off access point of a commercial flush valve assembly.

In an exemplary embodiment the technology described herein comprises a anti-theft assembly configured to protect access to the water shut-off access point. Since commercial flush valve assemblies may be in either a left or a right orientation, the paired access holes for a locking mechanism are positioned so the anti-theft assembly can be “flipped” over to be installed in either orientation. In addition the paired apertures are positioned towards the distal end of the anti-theft assembly so that a locking mechanism will be positioned between the wall and the plumbing, making the locking mechanism inaccessible to a cutting tool.

In one embodiment the anti-theft assembly 010 is comprised of an anti-theft base 100 and a shank lock assembly 200. The anti-theft base is comprised of a front side 110, a rear side 120, a top side 130, a bottom side 140, a right side 150 and a left side 160. The rear side 120 is partially open and configured to mate with the front portion of a commercial toilet water cut-off key plumbing fixture. The left side 160 is substantially open and dimensioned to fit the portion of the inlet plumbing fixture connected to the water cut-off key assembly. The top side 130 has at least one top side aperture 135 dimensioned for receiving a shank portion of a shank lock. The bottom side 140 has at least one bottom side aperture 145 disposed opposite a corresponding top side aperture 135 and also dimensioned for receiving the shank portion of a shank lock after it passes through the corresponding top side aperture 135.

The shank lock assembly 200 is comprised of shank lock base 220, a shank lock shank rotatably connected to the shank lock base 220, and a shank lock key 230.

In another embodiment the shank lock assembly is replaced by a substantially cylindrical lock support 300. The lock support 300 has a proximal end 310 and a distal end 320. The proximal end 310 terminates with a bolt-head 315. The distal end 320 has a lock support aperture 325 near the distal end 320, dimensioned for securement with a lock 400. The at least one top side aperture 135 and the at least one bottom side aperture 145 are dimensioned for insertion of the lock support 300.

Reference Table

| Reference Number | Description |
|---|---|
| 010 | Anti-Theft Assembly |
| 100 | Anti-Theft Base |
| 110 | Front Side |
| 120 | Rear Side |
| 130 | Top Side |
| 135 | Top Side Aperture |
| 140 | Bottom Side |
| 145 | Bottom Side Aperture |
| 150 | Right Side |
| 160 | Left Side |
| 200 | Shank Lock Assembly |
| 210 | Shank Lock Shank |
| 220 | Shank Lock Base |
| 230 | Shank Lock Key |
| 300 | Lock Support |
| 310 | Proximal End |
| 315 | Bolt-Head |
| 320 | Distal End |
| 325 | Lock Support Aperture |
| 400 | Lock |

Although this technology has been illustrated and described herein with reference to preferred embodiments and specific examples thereof, it will be readily apparent to those of ordinary skill in the art that other embodiments and examples can perform similar functions and/or achieve like results. All such equivalent embodiments and examples are within the spirit and scope of the disclosed technology and are intended to be covered.

What is claimed is:

1. An anti-theft assembly adapted for use with a commercial toilet water shutoff valve assembly, the anti-theft assembly includes an anti-theft base; the anti-theft base is comprised of a front side, a rear side, a top side, a bottom side, a right side and a left side; the rear side is partially open and adapted to mate with a front portion of the commercial toilet water cut-off valve assembly; the left side is substantially open and adapted to receive a portion of an inlet plumbing fixture connected to the water shutoff valve assembly; the top side has at least one top side aperture dimensioned for receiving a shank lock shank of a shank lock; the bottom side has at least one bottom side aperture disposed opposite the corresponding at least one top side aperture and is also dimensioned for receiving the shank lock shank after it passes through the corresponding at least one top side aperture.

2. The anti-theft assembly of claim 1, wherein the anti-theft base is metal.

3. The anti-theft assembly of claim 2, wherein the metal is stainless steel.

3. The anti-theft assembly of claim 1, wherein the anti-theft base is plastic.

4. An anti-theft assembly adapted for use with a commercial toilet water shutoff valve assembly, the anti-theft assembly is comprised of an anti-theft base and a shank lock assembly; the shank lock assembly is comprised of shank lock base, a shank lock shank rotatably connected to the shank lock base, and a shank lock key; the anti-theft base is comprised of a front side, a rear side, a top side, a bottom side, a right side and a left side; the rear side is partially open and adapted to mate with a front portion of the commercial toilet water cut-off valve assembly; the left side is substantially open and adapted to receive a portion of an inlet plumbing fixture connected to the water shutoff valve assembly; the top side has at least one top side aperture dimensioned for receiving the shank lock shank; the bottom side has at least one bottom side aperture disposed opposite the corresponding at least one top side aperture and is also dimensioned for receiving the shank lock shank after it passes through the corresponding at least one top side aperture.

5. The anti-theft assembly of claim 4, wherein the anti-theft base is metal.

6. The anti-theft assembly of claim 5, wherein the metal is stainless steel.

7. The anti-theft assembly of claim 4, wherein the anti-theft base is plastic.
